(19) United States
(12) Patent Application Publication
(10) Pub. No.: US 2003/0226315 A1
(43) Pub. Date: Dec. 11, 2003

(54) Device for holding panels and separating element

(75) Inventors: Gregor Haab, Baar (CH); Hans Wuthrich, Wettswil (CH)

Correspondence Address: OLIFF & BERRIDGE, PLC, P.O. BOX 19928, ALEXANDRIA, VA, 22320, US

(73) Assignee: HAWA AG, Mettmenstetten (CH)

(21) Appl. No.: 10/407,205

(22) Filed: Apr. 7, 2003

(30) Foreign Application Priority Data
Apr. 23, 2002 (EP) 02 405 329.0

(51) Int. Cl. E05D 15/26

(52) U.S. Cl. 49/127

(57) ABSTRACT

The device (1) according to the invention, which is used for positively holding a panel (40), in particular a glass panel, has at least one supporting element (30) which can be guided through a preferably circular hole (41) in the panel (40) and by means of which a first profile element (10) and a second profile element (20), which are arranged on opposite sides of the panel (40), can be connected to each other. According to the invention, the supporting element (30) has a head part (31), which is held displaceably in a receiving groove (13) provided in the first profile element (10), and a connecting part (32) which is to be guided through the hole (41) and has a threaded drill hole (33) which is provided for receiving an installation screw (35) used for connecting the second profile element (20).

The invention relates to a device for holding panels, in particular glass panels, and to a separating element provided with a panel according to the precharacterizing clause of Patent claims 1 and 11.

In order to separate or form rooms or in order to close off room or window openings, use is often made of glass or wooden walls, screens, doors or blinds, referred to in the following as separating elements, which are fitted in a fixed manner or are fastened to running mechanisms which can be displaced along a rail and, if appropriate, are mounted in a manner such that they can rotate.

Devices for holding glass panels are disclosed, for example, in WO 02/10544 A1 or EP 0 940 542 A2. These objects have a clamping device having two elements which can be displaced relative to each other by means of a screw and between which a glass panel is non-positively held.

Devices, by means of which glass panels can be positively held, are also known. For example, WO 98/59140 A1 discloses a device in which two fastening parts which are to be fitted into a recess in a glass panel can be connected to each other by means of a connecting part which can be guided through a drill hole provided in the glass panel and therefore positively holds the latter. In this case, the glass panel can be adjusted by means of an eccentric adjusting element which is introduced into the drill hole. This enables inaccuracies which have been produced during the processing of the glass panel to be compensated for.

A further adjusting element used for the adjustable fastening of a glass panel is described in EP 0 586 840 A1.

However, only relatively small deviations can be corrected by means of adjusting elements of this type, with the result that in the case of these devices, the processing of the glass panel has to take place in each case with high precision. All of the parts of the sliding element may already have been finished at the factory, so that corresponding transportation costs result. Furthermore, deviations from designated dimensions often also occur at the installation site and so adjustments also in situ are generally unavoidable.

In the case of the device disclosed in EP 0 586 840 A1, the glass panel can furthermore be displaced along a frame strip, after which it is fixed in place by wedging and bonding with putty. This is associated with a not inconsiderable outlay. Further adjustments may also be required later which, after the glass panel has been cemented with putty, results in further expense.

The present invention is therefore based on the object of providing a device for holding panels, in particular glass panels, and a separating element provided with a device of this type, which is not afflicted with the deficiencies described.

In particular, a device which is suitable for positively holding panels is to be provided, which device can be fitted with little outlay and can be connected to a panel in such a manner that the latter can be precisely adjusted with simple measures.

Furthermore, the device is to permit the holding of panels which are prepared for installation with the reduced outlay on processing.

Furthermore, a separating element provided with at least one device of this type is to be specified.

This object is achieved with a device and a separating element having the features specified in claims 1 and 11, respectively. Advantageous refinements of the invention are specified in further claims.

The device according to the invention, which is used for positively holding a panel, in particular a glass panel, has at least one supporting element which can be guided through a preferably circular hole in the panel and by means of which a first profile element and a second profile element, which are arranged on opposite sides of the panel, can be connected to each other. According to the invention, the supporting element has a head part, which is held displaceably in a receiving groove provided in the first profile element, and a connecting part which is to be guided through the hole in the panel and has a threaded drill hole which is provided for receiving an installation screw used for installing the second profile element.

The first and second profile elements which are connected to each other form a U-profile which grasps the panel on one side and is held in a designated position by means of the supporting elements. Unless the supporting elements are fixed in place, which can take place by tightening the installation screws or by means of threaded pins, the supporting elements, the two profile elements and the panel can be displaced relative to one another, so that, for example, the supporting elements can be displaced with respect to the holes provided in the panel and subsequently the first profile element and the panel, which is already held by the device but is not yet secured, can be displaced relative to one another until their end sides lie in a plane.

In a preferred refinement of the invention, the fixing of the supporting elements in a position designated for this purpose takes place by means of a threaded pin which is introduced into the threaded drill hole completely piercing the supporting element, and is screwed against the first profile element.

The threaded pin is preferably provided on the front side with a cup point which, when the threaded pin is tightened, engages positively in the first profile element, as a result of which the supporting element is held non-displaceably even in the case of relatively large actions of force which are produced, for example, when a sliding door provided with a panel strikes against a stop.

The supporting elements can be produced cost-effectively by a hollow-cylindrical connecting part being provided which is connected to a head part and is provided with a threaded drill hole running coaxially therein.

The receiving groove, which runs axially with respect to the first profile element and within which the supporting elements are displaceably held, is preferably formed by a C-profile-shaped supporting profile which partially surrounds the receiving groove by means of end pieces. The supporting element is held in this receiving groove in a displaceable and preferably rotationally fixed manner. For this purpose, the head part of the supporting element has, for example, a first and a second subsection which adjoin it axially with at least one segment having been removed, at least from the latter of the said subsections, in such a manner that it is held in a rotationally fixed and displaceable manner between the end pieces or by the entire supporting profile forming the receiving groove.

The rotationally fixed holding of the correctly positioned and fixed supporting elements is of importance for two reasons. Firstly, the installation screws, by means of which the second profile part is fitted, can be tightened without the supporting elements rotating at the same time. Furthermore, it is prevented that the threaded pins, which have been screwed in, can be loosened again during tightening of the installation screws.

The panel can therefore be precisely positioned and fixed in the horizontal direction, i.e. axially with respect to the profile elements. The positioning of the holes in the panel in the horizontal direction is thus not critical and can even be freely selected within a wide range.

During the preparation of the panel for the installation, deviations in position in the vertical direction of the holes used for receiving the supporting elements may also occur. In a preferred refinement of the invention, the connecting part of the supporting element is therefore provided for the axially parallel, eccentric mounting of a cylindrical adjusting element which can be correspondingly rotated within the associated hole for setting the position of the panel.

The introduction of the supporting elements in the receiving groove and the fitting and adjustment of the panel can take place in a simple manner before the second profile element is fitted by means of the installation screws. In contrast to a device used for non-positively holding the panel, the installation of the panel with the device according to the invention therefore takes place significantly more easily. The supporting elements can be positioned with just a few manoeuvres, after which the panel can be fitted. The displacement and adjustment of the panel can take place afterwards without there being the risk, as in the opening of a clamping device, that the panel may come loose from the device and bump against the floor.

The second profile element preferably has an installation rib which can be introduced into a holding groove provided in the first profile element, so that after fitting of the installation screws, which are introduced into the threaded drill holes of the supporting elements through openings in the second profile element, a stable, preferably positive connection between the first and second profile elements is produced.

The device according to the invention can be used advantageously for separating elements, for example wall elements or sliding doors, which are fitted in a fixed manner or are mounted displaceably. For this purpose, the first profile element is preferably provided with a guide profile which adjoins the supporting profile and runs parallel thereto and which has, for example, an outwardly open U-profile into which an installation block can be introduced and can be locked at a desired position. This permits individual positioning of supporting and guide parts, for example running mechanisms or guide pins, for each supporting element, which may be necessary, in particular in the case of systems in which a plurality of separating elements are parked in a stacked manner by means of parking rails which do not run parallel to one another.

A separating element can be provided with one or more devices according to the invention which are used to hold a panel, if appropriate a glass panel. For example, one or two devices can be provided on the upper side and/or the lower side of the panel. If only a single device is provided on one side, this can normally already be matched to the dimensions of the panel at the factory. If two devices are provided, they can be manufactured and supplied in a standardized embodiment for different lengths of the panel to be fitted.

The devices fitted to the separating elements can preferably be covered by means of covering elements with, for two devices arranged on one side of the panel, preferably just one covering being provided on each side.

The invention will be explained in greater detail below with reference to the drawings, in which:

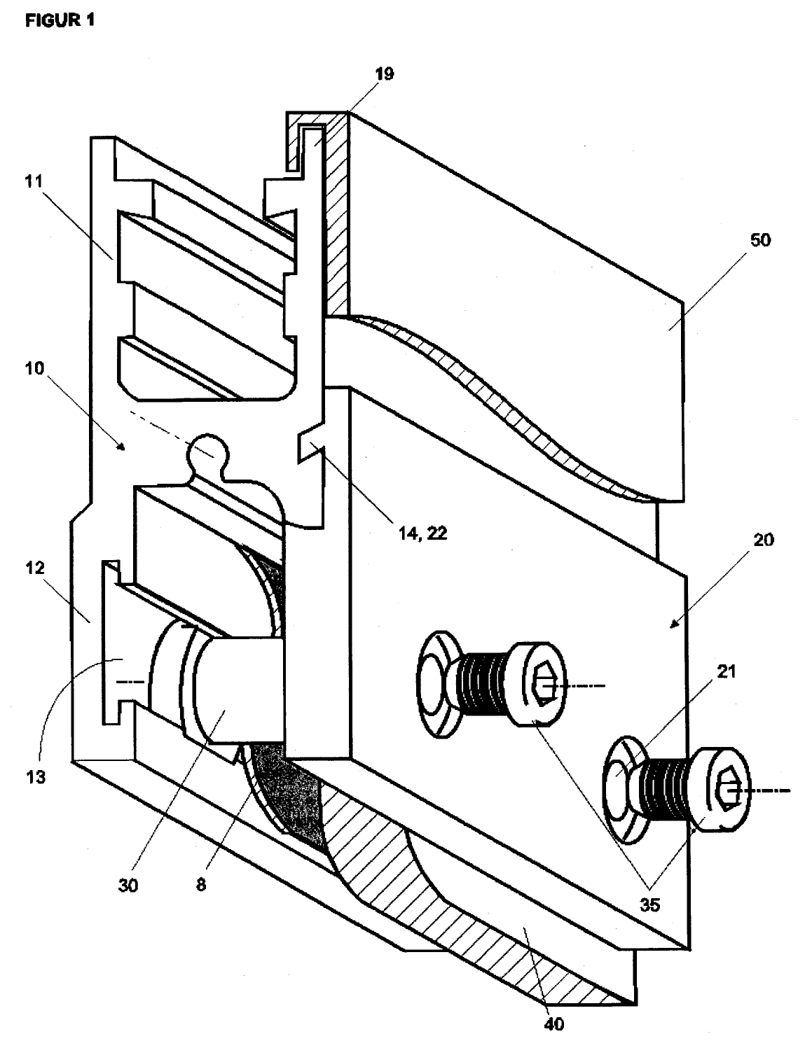

FIG. 1 shows a device 1 according to the invention having a first and a second profile element 10, 20, between which a panel 40 is held by means of supporting elements 30,

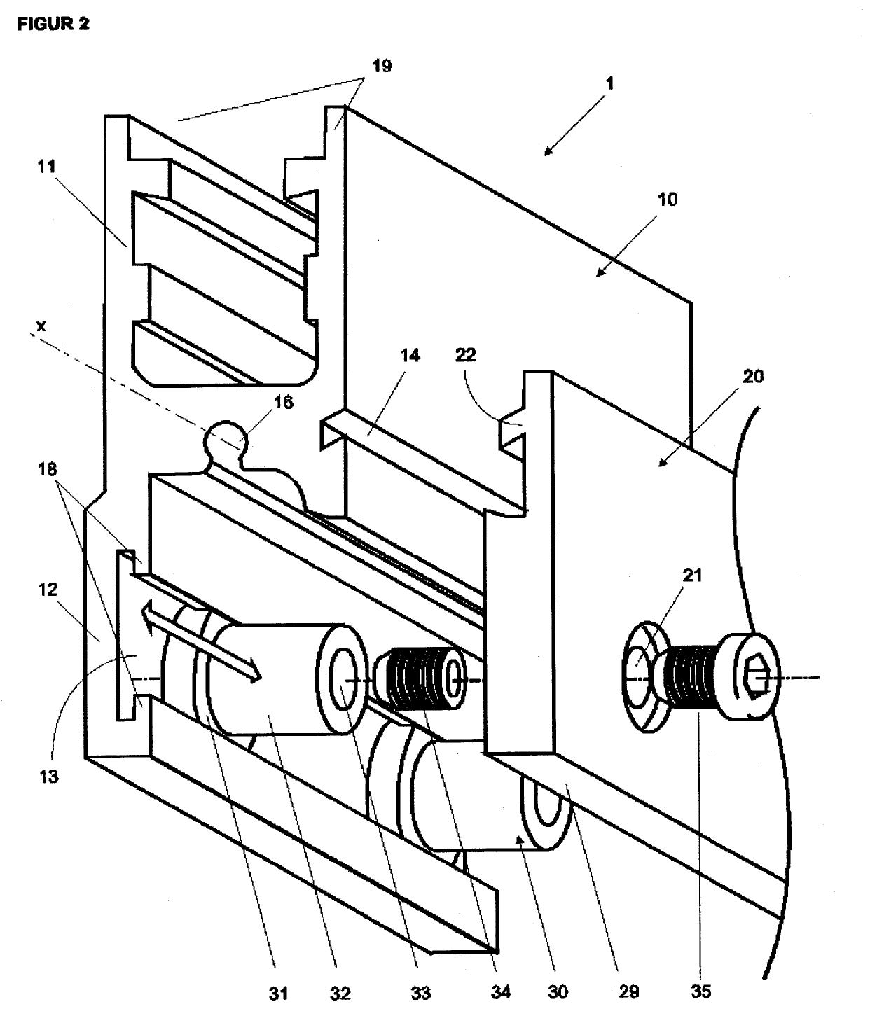

FIG. 2 shows the device 1 from FIG. 1 with the second profile element 20 removed,

FIG. 3 shows a frontal illustration of the device 1 from FIG. 1 with the panel 40 inserted,

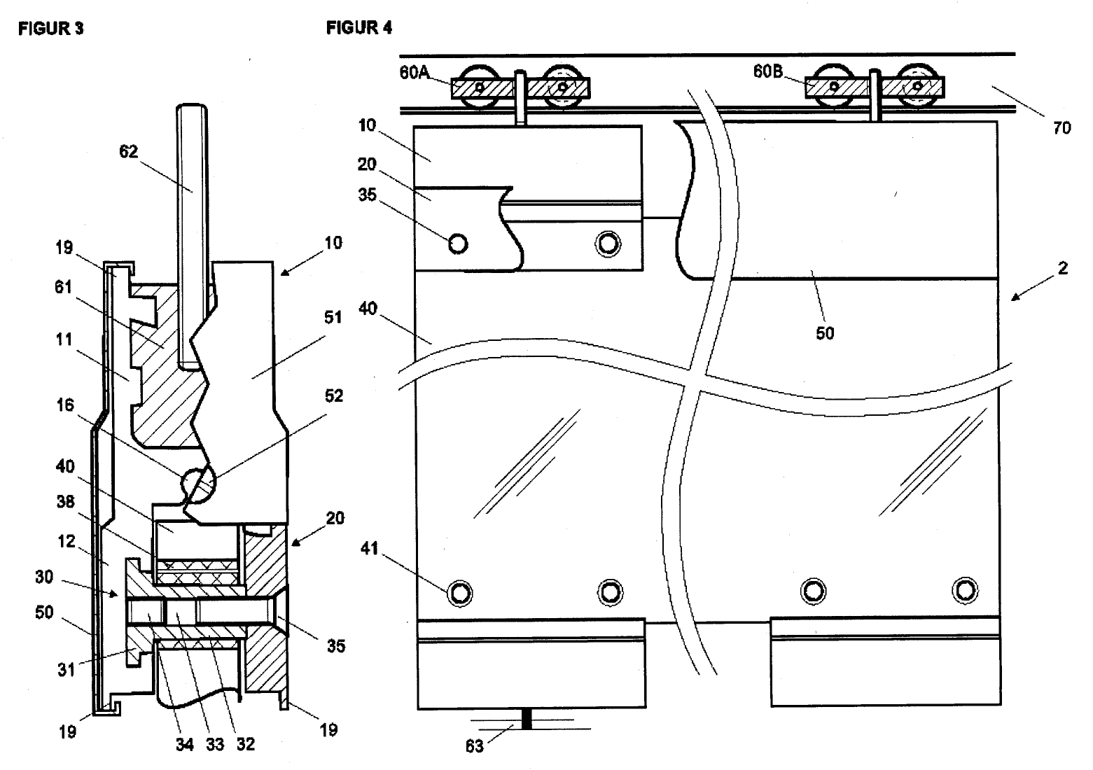

FIG. 4 shows a first separating element 2 provided with four devices 1 according to the invention,

FIG. 5 shows a second separating element 3 provided on the upper side with just one device 1 according to the invention,

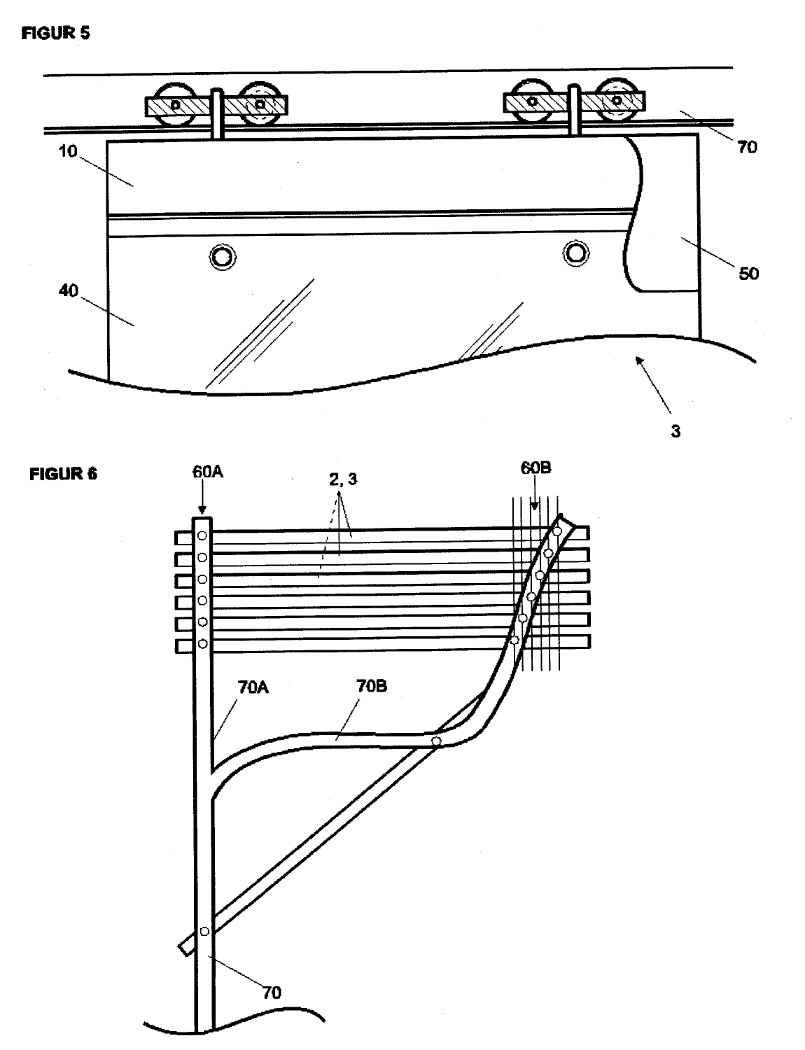

FIG. 6 shows a system for the stacked parking of separating elements 2, 3,

FIG. 7 shows the first profile element 10 with a supporting element 30 inserted therein into a receiving groove 13, and an adjusting element 38 placed thereon,

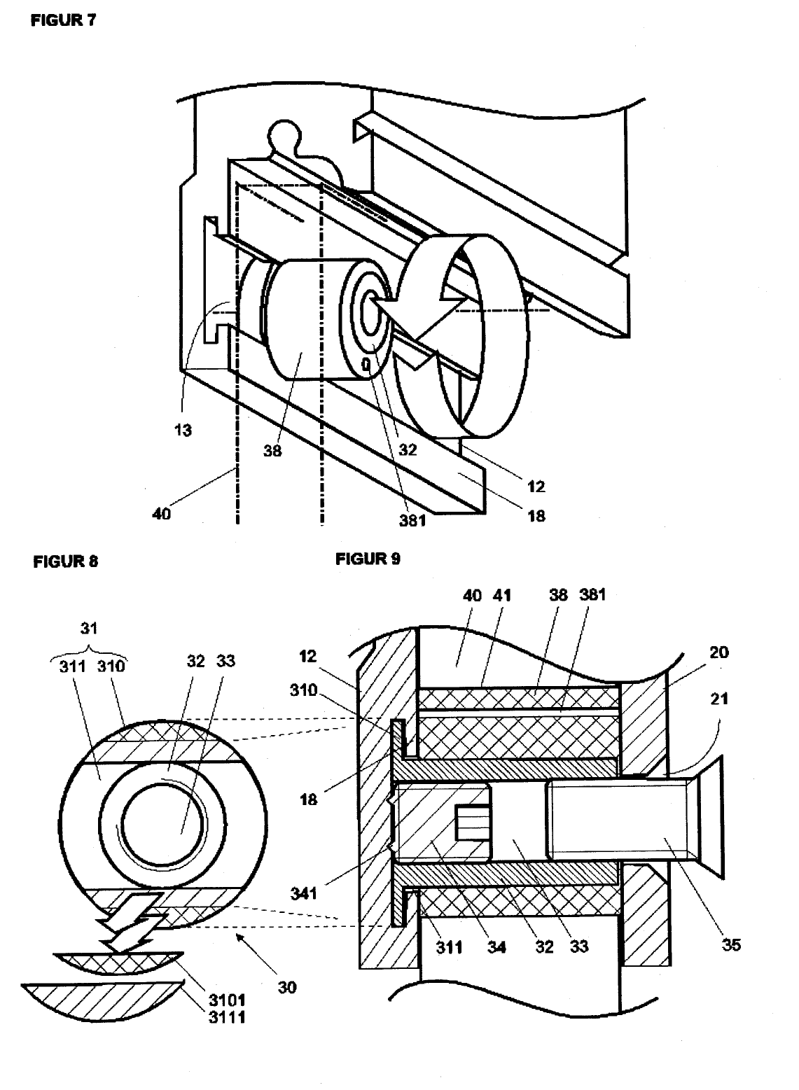

FIG. 8 shows the removed supporting element 30, as seen from the front, with a head part 31 comprising two subsections 310, 311, and a hollow-cylindrical connecting part 32 which is connected thereto and is provided with a threaded drill hole 33, and

FIG. 9 shows the device 1 which is connected to a panel 40 with the two profile elements 10, 20, the supporting element 30, a threaded pin 34 inserted therein, an installation screw 35 and the adjusting element 38, in a sectional illustration.

FIG. 1 shows a device 1 according to the invention having a first and a second profile element 10, 20 which are connected to each other, and a panel 40 which is held positively in between by means of supporting elements 30 and has holes 41, if appropriate openings having a circular cross section, for guiding the supporting elements 30 through (see FIG. 4). FIG. 2 shows the device 1 from FIG. 1 with the second profile element 20 removed and with the panel 40 removed.

It is apparent from FIGS. 1 and 2 that the first profile element 10 has a guide profile 11 and a supporting profile 12.

The U-profile-shaped guide profile 11 is used, as shown in FIGS. 3, 4 and 5, for receiving an installation block 61 which, in the designs shown, is connected by means of a connecting screw 62 to a running mechanism 60 guided in a guide rail 70. The guide profile 11 can be adapted to the respective conditions by means of expert measures. For example, the direct connection of the device 1 to the brickwork is possible. For this purpose, the guide profile 11 could merely be provided with at least one flange.

The supporting profile 12 is of C-profile-shaped designed in such a manner that an at least approximately T-profile-shaped receiving groove 13 is formed which is open towards the second profile element 20, runs parallel to a longitudinal axis x of the first profile element 10 and is partially surrounded by end pieces 18 of the C-profile, which end pieces are directed towards each other.

The supporting elements 30, which are shown in FIG. 2, have a head part 31 which can be introduced into the receiving groove 13, and a hollow-cylindrical connecting part 32 having a threaded drill hole 33 which is provided for receiving an installation screw 35 used for connecting the second profile element 20. The supporting elements 30 can therefore be displaced along the receiving groove 13 and can therefore be positioned as required.

A threaded pin 34 is preferably provided for fixing the supporting elements 30 in a desired position within the receiving groove 13, which threaded pin can be introduced into the threaded drill hole 33 which completely pierces the supporting element 30. As shown in FIG. 9, the threaded pin 34 can be screwed against the supporting profile 12 in such a manner that the supporting element 30 is held non-displaceably. The threaded pin 34 is preferably provided on the front side with a cup point 341 which can be screwed positively into the supporting profile 12 and thereby ensures a good connection.

It is furthermore shown in FIG. 8 and FIG. 9 that the head part 31 of the supporting element 30 has a first and a second subsection 310 and 311 adjoining it axially with at least one segment 3101; 3111 having been removed, at least from the latter of the said subsections, in such a manner that the supporting element 30 is held in a rotationally fixed, but displaceable, manner between the end pieces 18 or by the entire supporting profile 12 forming the receiving groove 13.

The supporting elements 30 are therefore held fixedly in the receiving groove 13 after fixing the threaded pins 34, so that the installation screws 35 can be screwed in without any problem without the positive connection between the threaded pins 34 and the supporting profile 12 being released by rotation of the supporting elements 30.

In the refinement of the device 1 shown in FIG. 7 and FIG. 9, the connecting part 32 of the supporting element 30 is also used for the eccentric mounting of a cylindrical adjusting element 38 which can be correspondingly rotated within an associated hole 41 for setting the position of the panel 40. The required rotation can be brought about, for example, by means of a tool which can be introduced into a drill hole 381, which is designated for this purpose, in the adjusting element 38. The central axes of the connecting part 32 and of the adjusting element 38 run parallel to each other and are spaced apart from each other by an eccentricity. By means of a corresponding rotation of the adjusting element 38, a desired, vertical positioning of the held panel 40 can therefore be set during the installation.

The introduction of the supporting elements 30 into the receiving groove 13 and the fitting and adjusting of the panel 40 can take place in a simple manner before the second profile element 20 is fitted by means of the installation screws 35. The supporting elements 30 are brought into the required position with just a few manoeuvres, after which the panel 40 can be fitted. The horizontal and vertical adjustment of the panel 40 can then be carried out without there being the risk of the panel 40 being able to come loose again from the device 1.

After installation and adjustment of the panel 40, the device 1 is closed by means of the second profile element 20 which, in the refinement shown in FIG. 2, has an installation rib 22 which can be introduced into a holding groove 14 provided in the first profile element 10. The second profile element 20 can therefore be fitted comfortably into the holding groove 14 and can subsequently be fastened by means of the installation screws 35 which are guided through openings 21 in the second profile element 20 and are screwed to the supporting elements 30. By means of the two profile elements 10, 20, which are preferably connected positively to each other, a preferably symmetrical U-profile is therefore formed which, in an end region, surrounds the panel 40 which is held by the supporting elements 30. In order to avoid vibrations of the panel 40, tapes 8, which are preferably elastic, are provided between the two profile elements 10, 20 and the panel 40, as shown in FIG. 1, and are easily compressed during tightening of the installation screws 35, which can preferably be countersunk into the second profile element 20.

As shown in FIG. 3, the two profile elements 10, 20 preferably have means 16, 19 which permit the fastening of covering elements 50, 51 which can be used to cover the fitted device 1 on one side, on both sides, on the front side and/or on the rear side. A screw channel 16 is provided on the front side and is used for receiving a screw 52 by means of which a front covering 51 can be fitted. For the lateral fastening of covering elements 50, the profile elements 10, 20 preferably have short wing elements 19.

FIGS. 4 and 5 show separating elements 2; 3, for example wall elements or sliding doors, which are provided with devices 1 according to the invention and are mounted in a manner such that they can be displaced by means of running mechanisms 60A, 60B guided in rails 70. The running mechanisms 60A, 60B are connected to the associated device 1, for example by means of an installation block 61, which is introduced into the guide profile 11, and a connecting screw 62.

Each installation block 61 can preferably be displaced within the guide profile 11, which has an outwardly open U-profile, and can be locked at a desired position. This permits individual positioning of supporting and guide parts, for example the running mechanisms 60A, 60B or guide pins 63, which may be required in particular in the case of systems in which a plurality of separating elements 2; 3 are parked in a stacked manner by means of parking rails 70A, 70B not running parallel to one another. A system of this type, in which a guide rail 70 is divided into two parking rails 70A, 70B, is shown in FIG. 6. It can be seen here that the distances between the running mechanisms 60A, 60B are set differently for each of the separating elements 2 and 3.

The separating element 2 shown in FIG. 4 is provided on the upper side and the lower side with two devices 1 according to the invention in each case which are connected to running mechanisms 60A, 60B and guide pins 63 and are clad by means of coverings 50. The devices 1 shown in FIG. 4 can therefore be used irrespective of the dimensions of the panel 40 to be held.

FIG. 5 shows a further separating element 3 which is provided on the upper side with just one device 1 according to the invention, the dimensions of which have preferably already been adapted at the factory to the panels 40 to be fitted.

The device 1 according to the invention has been described and illustrated in a preferred refinement. However, further expert refinements can be realized using the teaching according to the invention. In particular, various refinements and dimensions of the device parts, in particular of the profile parts, can be selected and various manufacturing materials, preferably light metals, such as aluminium, can be used for their production.

### List of Reference Numbers

| | |
|---|---|
| 1 | Holding device |
| 2 | Elastic tape |
| 10 | First profile element |
| 11 | Guide profile |
| 12 | Supporting profile |
| 13 | Receiving groove |
| 14 | Holding groove |
| 16 | Screw channel |
| 18 | Groove wing |
| 19 | Wing element |
| 20 | Second profile element |
| 21 | Opening in the second profile element 20 |
| 22 | Installation rib |
| 30 | Supporting element |
| 31 | Head part |
| 310 | First subsection |
| 3101 | First segment |
| 311 | Second subsection |
| 3111 | Second segment |
| 32 | Connecting part |
| 33 | Threaded drill hole |
| 34 | Threaded pin |
| 341 | Cup point |
| 35 | Installation screw |
| 38 | Adjusting element |
| 381 | Drill hole in the adjustment element 38 |
| 40 | Glass panel |
| 41 | Hole in the glass panel 40 |
| 50 | Covering element |
| 51 | Front covering |
| 52 | Fastening screw for the front covering |
| 60 | Running mechanism |
| 61 | Installation block |
| 62 | Connecting screw |
| 63 | Guide pin |
| 70 | Guide rail |

1. Device (1) for positively holding a panel (40), in particular a glass panel, having at least one supporting element (30) which can be guided through a hole (41) in the panel (40) and by means of which a first profile element (10) and a second profile element (20), which are arranged on opposite sides of the panel (40), can be connected to each other, characterized in that the supporting element (30) has a head part (31), which can be displaced and locked in a receiving groove (13) running in the first profile element (10) parallel to the longitudinal axis x thereof, and a connecting part (32) which is to be guided through the hole (41) and has a threaded drill hole (33) which is provided for receiving an installation screw (35) used for connecting the second profile element (20).

2. Device (1) according to claim 1, characterized in that a threaded pin (34) is provided in the threaded drill hole (33), which completely pierces the supporting element (30), the said threaded pin being screwed against the first profile element (10) in such a manner that the supporting element (30) is held non-displaceably in a position designated for this purpose.

3. Device (1) according to claim 1 or 2, characterized in that the threaded pin (34) is provided on the front side with a cup point (341).

4. Device (1) according to claim 1, 2 or 3, characterized in that the connecting part (32) is a hollow cylinder having a threaded drill hole (33) running coaxially in it.

5. Device (1) according to one of claims 1 to 4, characterized in that the first profile element (10) is provided with a supporting profile (12) which has a C-profile with end pieces (18) directed towards each other, for forming the receiving groove (13).

6. Device (1) according to claim 5, characterized in that the head part (31) of the supporting element (30) has a first and a second subsection (310 and 311, respectively) which adjoin it axially, with at least one segment (3101; 3111) having been removed, at least from the latter of the said subsections, in such a manner that it is held in a rotationally fixed and displaceable manner between the end pieces (18) or by the entire supporting profile (12) forming the receiving groove (13).

7. Device (1) according to one of claims 1 to 6, characterized in that the connecting part (32) is used for the axially parallel, eccentric mounting of a cylindrical adjusting element (38) which can be correspondingly rotated within the associated hole (41) for setting the position of the panel (40).

8. Device (1) according to one of claims 1 to 7, characterized in that the first profile element (10) has a guide profile (11) which adjoins the supporting profile (12) and runs parallel thereto and which is provided with a holding groove (14) used for receiving an installation rib (22) arranged on the second profile element (20), and/or which has an outwardly open U-profile used for receiving an installation block (61) which can be displaced and can be locked within the U-profile.

9. Device (1) according to claim 8, characterized in that the installation block (61) can be connected, if appropriate by means of a connecting screw (62), to a running mechanism (60) guided in a guide rail (70) or to a further guide element (63).

10. Device (1) according to one of claims 1 to 9, characterized in that means (19) are provided for holding covering elements (50) which can be used to cover at least one fitted device (1) on one side or on both sides.

11. Separating element, in particular wall element or sliding door, having at least one device (1) for holding a panel (40) according to one of claims 1 to 10, characterized in that the panel (40) is provided on the upper side and/or the lower side with a device (1) matched to the length of the panel (40) or in that the panel (40) is provided on the upper side and/or the lower side with at least two devices (1) in each case.

12. Separating element according to claim 11, characterized in that the devices (1) are connected to guide elements, if appropriate to running mechanisms (60) guided in rails (70).

13. Separating element according to claim 11 or 12, characterized in that the devices (1) are covered by covering elements (50) with, for two devices (1) arranged on one side of the panel (40), just one covering being provided on each side.
